(19) United States
(12) Patent Application Publication
(10) Pub. No.: US 2014/0083387 A1
(43) Pub. Date: Mar. 27, 2014

(54) COATING MATERIAL FOR INTAKE/EXHAUST VALVE AND METHOD FOR MANUFACTURING THEREOF

(71) Applicant: Hyundai Motor Company, Seoul (KR)

(72) Inventor: Sung-Chul Cha, Seoul (KR)

(21) Appl. No.: 13/927,572

(22) Filed: Jun. 26, 2013

(30) Foreign Application Priority Data
Sep. 21, 2012 (KR) 10-2012-0105077

(51) Int. Cl. F16K 27/00; C23C 28/00

(52) U.S. Cl. CPC F16K 27/00; C23C 28/343
USPC 123/188.11; 427/576

(57) ABSTRACT

Disclosed is a coating material for intake/exhaust valves and a method for manufacturing the same. The coating material comprises: a Cr or Ti bonding layer formed on a mother material which makes up the intake/exhaust valve; a WC, CrN, TiN or TiCN support layer that is disposed on a surface of the boding layer; and a Si-DLC or SiO-DLC functional layer that is disposed on a surface of the support layer. According to the present invention, wear resistance and heat resistance of the valve are improved.

### CROSS-REFERENCE TO RELATED APPLICATION

The present application claims priority of Korean Patent Application Number 10-2012-0105077 filed Sep. 21, 2012, the entire contents of which application is incorporated herein for all purposes by this reference.

### BACKGROUND

(a) Technical Field

The present invention relates to a coating material for intake/exhaust valves and a method for manufacturing the coating material, more particularly wherein the coating material has a Cr or Ti bonding layer, a WC, CrN or Ti(C)N supporting layer, and a Si(O)-DLC functional layer in sequence. The present invention further relates to a valve coated with the coating material and having improved wear resistance and heat resistance.

(b) Background Art

Generally, the properties of components for a vehicle are dependent on the types of materials, composition, manufacturing procedure, surface grinding, and heat treatment, etc. used in forming the components. In particular, during use the durability of the components decreases abruptly by thermal shock, sand burning and abrasion, etc.

FIG. 1 is a view showing a valve 100 mounted on a cylinder head port. In FIG. 1, the valve 100 serves as a shutter between a cylinder and an external part, an intake valve that inhales mixed air into a combustion room during an intake stroke of an engine cycle, and an exhaust valve that discharges combustion gas outside during an exhaust stroke. The components are moved linearly by a valve guide 110.

FIG. 2 is a view showing a configuration of the intake/exhaust valves wherein the valve 100 generally includes a face part 101, a stem part 102 and a tip part 103. Here, the face part 101 and the stem part 102 are made of different materials and are bonded by a friction-welding in order to ensure heat resistance and wear resistance, and the tip part 103 is treated with high frequency in order to ensure wear resistance and low friction and improve fuel efficiency.

Recently, the operational environments of engine components, including the valve 100, become severe due to increased engine output. Accordingly, to meet the environmental changes at high temperature, load and impact which are continuously applied in vehicles with gasoline engines and diesel engines, the intake/exhaust valves must possess high levels of physical properties and performance standards.

Accordingly, various efforts are being made to prevent shortening of a lifespan of the intake/exhaust valves and to maintain the performance thereof. For example, heat resistance steel with sufficient resistance against high temperature is used as material forming the valve 100. Further studies on surface treatment are being made in order to improve sticking resistance, wear resistance, low friction, and heat resistance, etc.

Conventionally, a surface of the valve is treated with softening or high frequency to improve the performance thereof. However, the surface is burnt and fused easily with oil carbide and the friction coefficient is high thereby decreasing a fuel ratio (i.e. fuel efficiency). Furthermore, hardness of the valves is uneven due to different heat treatments carried out around the valve 100 and is decreased due to reduced heat resistance.

The description provided above as a related art of the present invention is just for helping understanding the background of the present invention and should not be construed as being included in the related art known by those skilled in the art.

### SUMMARY OF THE DISCLOSURE

The present invention provides a coating material for intake/exhaust valves and a method for manufacturing the coating material. The present invention ensures heat resistance and sticking resistance of the coated part 101, improves a fuel ratio due to improved wear resistance and low friction of the stem part 102 and the valve guide 110 which are thus reduced in wear, and further improves the fuel ratio due to wear resistance and low friction of the tip part 103.

According to one aspect, the present invention provides a coating material for intake/exhaust valves comprising a Cr or Ti bonding layer formed on a mother material (the mother material referring to the material forming the intake/exhaust valve itself); a WC, CrN, TiN or TiCN support layer that is disposed on a surface of the boding layer; and a Si-DLC or SiO-DLC functional layer that is disposed on a surface of the support layer. According to preferred embodiments, these layers are disposed directly on each other without layers or materials interposed therebetween. In other words, preferably the bonding layer is directly formed on the mother material, the support layer is directly formed on the bonding layer, and the functional layer is directly disposed on the support layer. Preferably, the individual layers are separate layers such that the layers do not overlap each other (i.e. the components of bonding layer materials and the support layer materials preferably do not mix and blend, but rather, discrete individual layers are preferably formed). Further, it is preferred that the bonding layer covers an entire outer surface of a valve (an entire surface of the mother material), the support layer covers an entire outer surface of the bonding layer, and the functional layer covers an entire outer surface of the support layer. In other words, preferably there are no gaps in the various layers.

The thicknesses of the bonding layer, support layer and functional layers may be similar to each other, and preferably the thickness of the bonding layer is less than the thickness of the support layer and functional layer. Further, the thickness of the support layer may be less than of the functional layer. According to various embodiments, a thickness of the bonding layer is about 0.01-0.5 μm, a thickness of the support layer is about 0.1-5 μM, and a thickness of the functional layer is about 0.1-10 μm.

According to various embodiments, an atomic percentage of Si in the functional layer is about 4 to 12%.

According to another aspect, the present invention provides a method for manufacturing to coating material for intake/exhaust valves comprising: providing a chamber in vacuum state and changing the vacuum state into a plasma state; disposing an intake/exhaust valve within the chamber and depositing a Cr or Ti bonding layer on a surface of a mother material forming the intake/exhaust valve; depositing a WC, CrN, TiN or TiCN support layer on a surface of the bonding layer; and depositing a Si-DLC or SiO-DLC functional layer on a surface of the support layer. Preferably, the steps of forming the bonding layer, the support layer and the functional layer are carried out so that the bonding layer is directly formed on the mother material, the support layer is directly formed on the bonding layer, and the functional layer is directly formed on the support layer.

According to various embodiments, prior to application of the bonding layer the surface of the mother material is activated and/or washed.

According to various embodiments, a thickness of the bonding layer is about 0.01-0.5 μm, a thickness of the support layer is about 0.1-5 μm, and a thickness of the functional layer is about 0.1-10 μm.

According to various embodiments, an atomic percentage of Si in the functional layer is about 4 to 12%.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a perspective view showing a valve mounted to a port of a cylinder head as is conventional in the art;

FIG. 2 is a perspective view showing a conventional configuration of intake/exhaust valves;

FIG. 3 is a perspective view showing a configuration of an Si(O)-DLC coating material according to an embodiment of the present invention;

FIG. 4 is a perspective view showing a coating device for manufacturing the coating material according to an embodiment of the present invention;

FIG. 5 is a picture showing the valve of an engine after softening treatments of the valve of an engine according to a related art; and

FIG. 6 is a picture showing the valve of an engine after coating treatment of the valve of an engine according to an embodiment of the present invention.

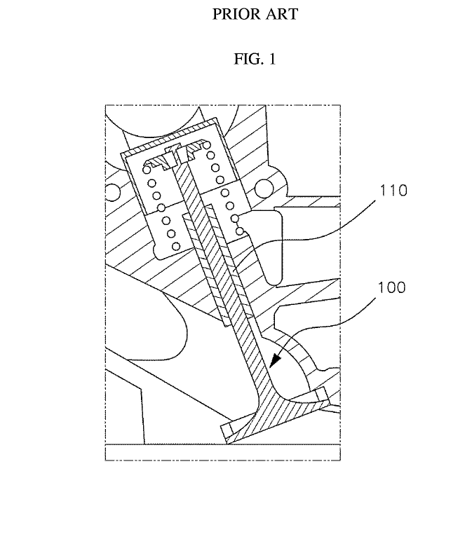

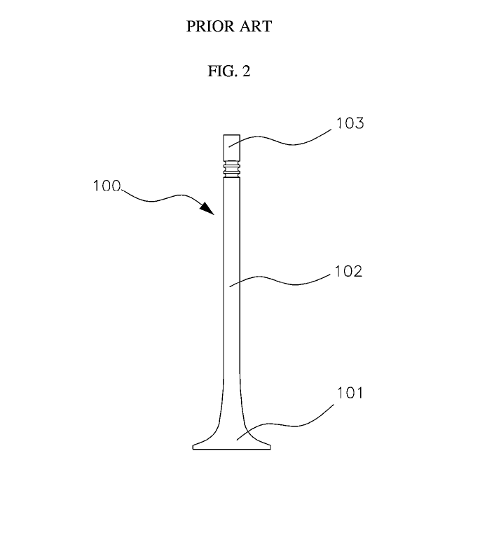

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, preferred examples of the present invention now will be described in detail with reference to the accompanying drawings. The terms and the words used in the specification and claims should not be construed with common or dictionary meanings, but construed as meanings and conception coinciding the spirit of the invention based on a principle that the inventors can appropriately define the concept of the terms to explain the invention in the optimum method. Therefore, embodiments described in the specification and the configurations shown in the drawings are not more than the most preferred embodiments of the present invention and do not fully cover the spirit of the present invention. Accordingly, it should be understood that there may be various equivalents and modifications that can replace those when this application is filed.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the present invention will be described in detail with referring to the accompanied drawings.

In one aspect, the present invention relates to a coating material for intake/exhaust valves, particularly to such a coating material that includes Si(O)-DLC functional layer as a main layer.

According to the related art, in case where a surface of the valve 100 is treated with softening or high frequency, the face part 101 of the valve 100 becomes fused with oil carbide. This sticking causes the hardness of the valve to be decreased, and further results in leakage of and/or damage to the valve. These problems are main reasons for the shortening of the lifespan thereof.

Generally, intake/exhaust valves are used under severe environmental conditions, such as high pressure and temperature. As such, the intake/exhaust valves must possess high physical properties to endure the severe environmental conditions. However, conventional softening and high frequency treatments are limited in their ability to improve heat resistance, wear resistance and sand sticking resistance.

Accordingly, the present invention provides a Si(O)-DLC coating material having the structure further described below. It is noted that herein, Si(O)-DLC refers to Si-DLC or SiO-DLC wherein DLC is Diamond Like Carbon.

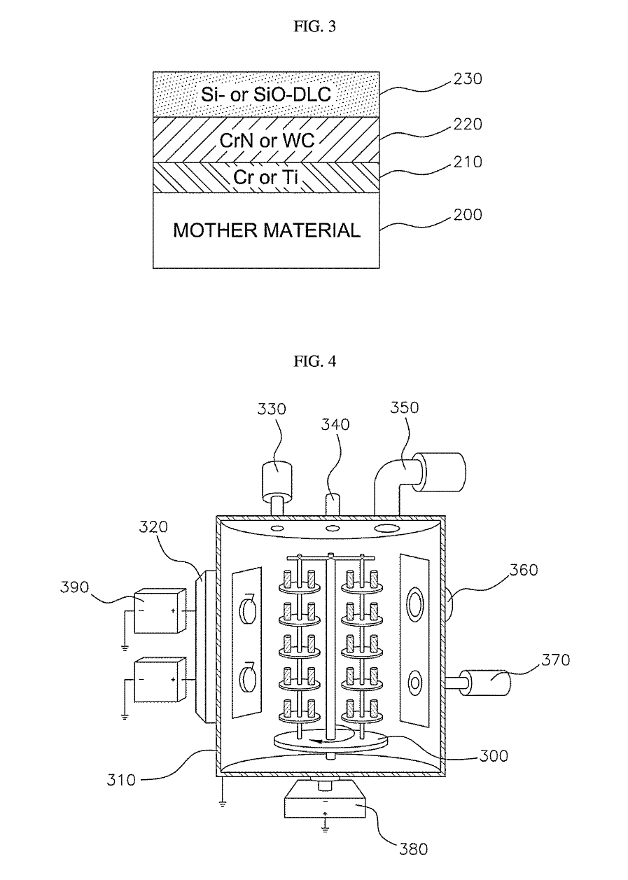

FIG. 3 is a perspective view showing a configuration of the Si(O)-DLC coating material according to an embodiment of the present invention.

As shown in FIG. 3, the coating material may comprise sequentially: a Cr or Ti boding layer 210 formed on a mother material 200; a WC, CrN or Ti(C)N support layer 220 formed on the bonding layer 210; and a Si(O)-DLC functional layer 230 formed on the support layer 220. As referred to herein, Ti(C)N refers to TiN or TiCN.

According to embodiments of the present invention, the mother material 200 of the valve 100 may comprise an ion nitride layer for providing wear resistance and toughness on its surface.

Meanwhile, the Cr or Ti bonding layer 210 may be used as a buffer layer for minimizing residual stress on the coating and improving adhering force between the coating layer and the mother material 200. The thickness of the bonding layer 210 is such that it provides these properties, and, preferably, the thickness of the bonding layer 210 is about 0.01-0.5 μM. Here, if the thickness is less than about 0.01 μM, the amount of the components in the bonding layer is not sufficient to fulfill the above functions, and if the thickness exceeds about 0.5 μM, the adhering property is deteriorated.

The Si(O)-DLC functional layer 230 provides improved sticking resistance, wear resistance, low friction and heat resistance, which are main features of the present invention. Here, the function layer may have a thickness suitable for providing these properties, and preferably is about 0.1-10 μm. If the thickness is less than about 0.1 μm, the amount of the components of the functional layer 230 is not sufficient to fulfill the above functions, and if the thickness exceeds to 10 μm, the coating layer is more readily peeled off.

According to preferred embodiments, the Si(O)-DLC function layer 230 comprises Si in an amount of about 4-12 at %. If the content of Si is less than about 4 at %, the low friction and the sticking resistance are decreased, and if the content thereof exceeds about 12 at %, the hardness is decreased.

Generally, it is difficult to simultaneously improve the wear resistance and impact resistance of a material, which are opposing properties. According to the present invention, the coating material is multi-layered, with different layers contributing to different properties. In particular, according to a preferred embodiment, the coating material comprises a support layer 220 having excellent impact resistance and a functional layer 230 having excellent wear resistance to thereby simultaneously improve both physical properties. The support layer 220 may be provided as a middle layer and the functional layer 230 may be provided as an outer layer.

In another aspect, the present invention relates to a method for manufacturing a coating material for intake/exhaust valves, the coating layer comprising a Si(O)-DLC functional layer 230, wherein the coating material is provided on the intake/exhaust valves using PVD or PACVD.

Here, the PVD method refers to Physical Vapor Deposition, and the PACVD method refers to Plasma-Assisted Chemical Vapor Deposition. Such methods are known and, thus, the general steps and conditions for carrying out PVD and PACVD can be in accordance with those conventionally used.

FIG. 4 is a perspective view showing a coating device for manufacturing the coating material according to an embodiment of the present invention. The coating device may include: a chamber 310; a target part 320 mounted on the chamber; a vacuum gage 300; a gas injection part 340; a discharging part 350; a window 360; a temperature measuring unit 370; a bias power unit 380; a coating power unit 390 and a rotatable holder 300 including the mother material 200 (not shown) within the chamber 310, as shown in FIG. 4.

At this time, the target part 320 may include a Cr target, a Ti target, a WC target or an SiC target, etc.

First, prior to the coating process, the inside of the chamber 310 may be evacuated by using a pump or the like, and then argon gas or the like is injected through the gas injection part 340 to thereby produce a plasma state.

Further, the chamber 310 may be heated to a suitable temperature (e.g. about 80° C.) to activate a surface of the mother material 200, and a bias power may be applied thereto through the bias power unit 380 to bombard the surface of the mother material with argon anode ions thereby washing it (i.e., baking and cleaning).

Next, a Cr or Ti boding layer 210 may be deposited in a suitable thickness, preferably a thickness of about 0.01-0.5 μm, on a surface of the mother material 200 by using the Cr target or Ti target (preferably through a PVD method).

After the bonding layer 210 is deposited, the WC support layer 220 may be deposited by using the WC target. Subsequent to depositing of the WC support layer 220, the CrN support layer 220 is then deposited by using the Cr target and N gas through the gas injection part 340. In particular, the TiN support layer 220 may be deposited by using the Ti target and N gas through the gas injection part 340 or the TiN support layer 220 may be deposited by using the Ti target and N gas and hydrocarbon gas through the gas injection part 340. The support layer 220 is deposited in a suitable thickness, preferably a thickness of about 0.1-5 μm (preferably through a PVD method).

Next, the Si-DLC functional layer 230 may be deposited with a chemical reaction by using the SiC target and hydrocarbon gas and Tetra-MethylSilane (TMS) gas through the gas injection part 340. Alternatively, a Si-DLC functional layer 230 may be deposited with a chemical reaction by using the SiC target and hydrocarbon gas and HexaMethylDiSilOxane (HMDSO) gas through the gas injection part 340. The functional layer 230 is deposited in a suitable thickness, preferably a thickness of about 0.1-10 μm (preferably through a PACVD method).

According to preferred embodiments, acetylene (C₂H₂) is used as the hydrocarbon gas. Of course, other conventional hydrocarbon gases could also suitably be used/

TABLE 1

| | | Embodiment of the |
|---|---|---|
| | Conventional Art | Present Invention |
| Surface treatment/coating | Softening | Si (O)-DLC |
| Hardness decreasing after | 30% | 0% |
| leaving it for 3 hours at | | |
| 500° C. | | |
| Friction coefficient (Dry) | 0.62 | 0.25 |
| Friction coefficient (Oil) | 0.116 | 0.042 |
| Eyesight of the sticking (after | Stuck surface | Non stuck surface |
| evaluation an engine) | | |
| Fuel ratio effect | — | 0.25% |

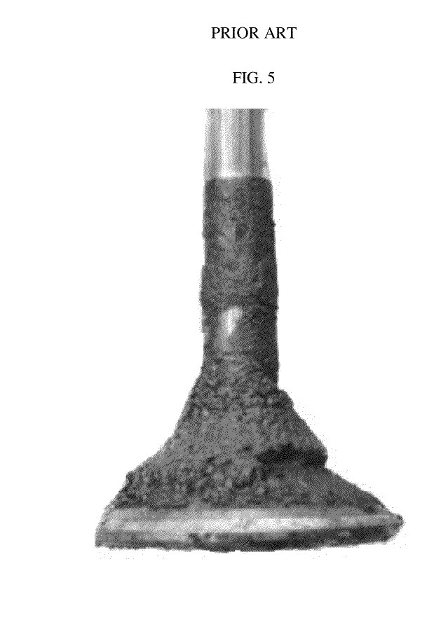

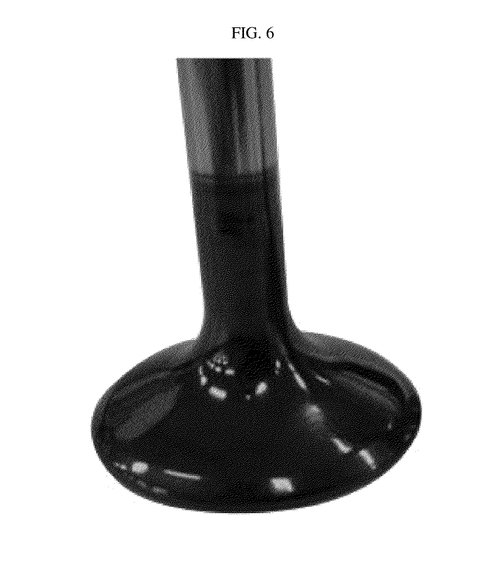

Table 1 shows a comparison between a valve 100 that was subjected to softening-treatment according to a related art and a valve 100 that was subjected to coating-treatment according to the present invention. FIG. 5 is a picture showing the valve of an engine after softening treatments of the valve of an engine according to a related art; and FIG. 6 is a picture showing the valve of an engine after coating treatment of the valve of an engine according to the present invention.

From Table 1, it can be seen that in case of the valve 100 that was subjected to conventional softening-treatment, the hardness was decreased to 30% when it was measured after leaving it for 3 hours at 500° C. On the other hand, in case of the valve that was subjected to coating-treatment according to the present invention, the hardness was not decreased under the same condition. This is resulted from improvement in heat resistance of the valve coated and treated according to the present invention.

Further, since the friction coefficient of the valve 100 that was subjected to coating-treatment according to the present invention as lower than that of the valve that was subjected to conventional softening-treatment, it was demonstrated that the wearing of the valve guide 110 was prevented and thus the fuel ratio was improved to 0.25% in the case of the present invention.

Furthermore, it was shown that in the case of the valve 100 according to the present invention, the sticking was not produced even after evaluating the engine, and thus the sticking resistance of the valve 100 according to the present invention was improved.

According to the present invention, the wear resistance and the heat resistance of the valve 100 are improved, as compared to a valve that is treated with conventional softening or high frequency. As such, the friction-bonding process using different materials can be eliminated.

Further, the fuel ratio when using the presently coated valves is improved due to low friction of the stem part 102 and the friction coefficient is lowered to prevent wearing of the valve guide 110, which is a material that comes into contact with the coated valve.

Furthermore, the presently coated valves do not possess unevenness of hardness of the valve 100, which typically results from different heat treatment on various parts of the valve. As a result, the coated valves of the present invention can be provided with a uniform hardness. Further, rigidity of the entire coated valve is ensured to thereby fulfill safe behavior of the valve during use.

The invention has been described in detail with reference to preferred embodiments thereof. However, it will be appreciated by those skilled in the art that changes or modifications may be made in these embodiments without departing from the principles and spirit of the invention, the scope of which is defined in the appended claims and their equivalents.

What is claimed is:

1. A coating material for intake/exhaust valves comprising:
a Cr or Ti bonding layer formed on a mother material of the intake/exhaust valve;
a WC, CrN, TiN or TiCN support layer disposed on a surface of the boding layer; and
a Si-DLC or SiO-DLC functional layer disposed on a surface of the support layer.

2. The coating material for intake/exhaust valves according to claim 1, wherein a thickness of the bonding layer is about 0.01-0.5 μm, a thickness of the support layer is about 0.1-5 μm, and a thickness of the functional layer is about 0.1-10 μm.

3. The coating material for intake/exhaust valves according to claim 1, wherein the bonding layer is disposed on an entire outer surface of the mother material, the support layer is disposed on an entire outer surface of the boding layer, and the functional layer is disposed on an entire outer surface of the support layer.

4. The coating material for intake/exhaust valves according to claim 1, wherein an atomic percentage of Si in the functional layer is about 4 to 12%.

5. A method for manufacturing the coating material for intake/exhaust valves comprising:
providing a chamber with a vacuum state and converting the vacuum state into a plasma state;
disposing the intake/exhaust valve formed of a mother material within the chamber, and depositing a Cr or Ti bonding layer on a surface of the mother material;
depositing a WC, CrN, TiN or TiCN support layer on a surface of the bonding layer; and
depositing a Si-DLC or SiO-DLC functional layer on a surface of the support layer.

6. The method for manufacturing the coating material for intake/exhaust valves according to claim 5, wherein the surface of the mother material is activated and washed prior to depositing the bonding layer.

7. The method for manufacturing the coating material for intake/exhaust valves according to claim 5, wherein a thickness of the bonding layer is about 0.01-0.5 μm, a thickness of the support layer is about 0.1-5 μm, and a thickness of the functional layer is about 0.1-10 μm.

8. The method for manufacturing the coating material for intake/exhaust valves according to claim 5, wherein an atomic percentage of Si in the functional layer is about 4 to 12%.
